(19) United States
(12) Patent Application Publication
(10) Pub. No.: US 2006/0050506 A1
(43) Pub. Date: Mar. 9, 2006

(54) Light diffuser element with brightness distribution control

(76) Inventor: Peter Y.Y. Ngai, Alamo, CA (US)

Correspondence Address: BEESON SKINNER BEVERLY, LLP, ONE KAISER PLAZA, SUITE 750, OAKLAND, CA, 94612, US

(21) Appl. No.: 11/220,357

(22) Filed: Sep. 6, 2005

Related U.S. Application Data
(60) Provisional application No. 60/607,289, filed on Sep. 3, 2004.

(51) Int. Cl. F21S 4/00

(52) U.S. Cl. 362/223; 362/225

(57) ABSTRACT

A diffuser element for a source of light is comprised of a body having an observable portion fabricated of a light diffusing material. The observable portion of the body has a light incident surface and a light exiting surface opposed to the light incident surface, each of which has a contoured surface pattern. The contours for the opposing contoured surface patterns are chosen to achieve a desired visual characteristic for the diffuser element including a desired brightness distribution across the contoured surface pattern of the light exiting surface.

### CROSS-REFERENCE TO RELATED APPLICATIONS

The application claims the benefit of provisional application No. 60/607,289, filed Sep. 3, 2004.

### BACKGROUND OF THE INVENTION

The present invention generally relates to lighting fixtures for illuminating a space, and more particularly to optical elements for lighting fixtures used to shield the light source and/or control distribution of light emitted from the lighting fixture.

It is well-known to use lenses or diffusers to shield the light source of a lighting fixture and to create a desired lighting performance, which can include a desired light distribution pattern and desired observable brightness characteristics. In many lighting applications, diffusers can advantageously be used to provide visually comfortable surfaces having mitigated brightness characteristics as compared to the high surface brightness of most light sources. For lighting fixtures using high output lamps with particularly high surface brightness, the use of diffusers is particularly desirable.

Diffusers are often fabricated of a diffuse plastic material, such as white opal acrylic, typically made in a sheet-like form shaped to a particular application. The diffuser will have two opposed surfaces, namely, an inner light incident surface which faces the light source, and an outer light exiting surface through which light is emitted into the illuminated space. Conventionally, one or both of these surfaces is a flat, smooth surface. Where both of the diffuser surfaces are parallel and smooth, the outer observable surface of the diffuser will exhibit substantially uniform brightness. However, smooth uniformly bright surfaces are not always desirable. Depending on the application, it may be desirable to provide the observable diffuser surface with a visible contoured surface and a brightness distribution that varies across the surface. Such variations and surface contours add visual interest to the lighting fixture on which the diffuser is used.

Heretofore, the designer has been constrained in his or her ability to design a diffuser having observable surfaces with both desired contoured shapes and desired brightness distribution patterns across the surface. Generally, the chosen contoured surfaced would dictate the brightness distribution pattern on the diffuser, or, if the diffuser were designed for a desired brightness distribution pattern, this would dictate the geometry of the contoured surface of the diffuser. The present invention is intended to overcome these limitations by permitting the designer to specify both the contoured shape of a diffuser surface according to the visual requirements of a particular application, as well as different brightness distribution patterns on the diffuser. No longer is the designer constrained to a brightness distribution pattern on the diffuser that is dictated by the surface contours on the diffuser's observable surface.

### SUMMARY OF THE INVENTION

Briefly, the present invention provides a diffuser element for a source of light comprised of a body having an observable portion fabricated of a light diffusing material. The observable portion of the body has a light incident surface and a light exiting surface opposed to the light incident surface. Each of these surfaces are contoured to produce opposing contoured surface patterns. The contours for the contoured surface pattern for the light exiting surface is chosen to achieve a desired visual characteristic for the light exiting surface, while the contours for the contoured surface pattern for the light incident surface is chosen to achieve a desired brightness distribution across the contoured surface pattern of the light exiting surface. Thus, by providing two opposed contoured surfaces on the diffuser body, the designer is able to specify both the contoured shape, as dictated by the visual requirements of a particular application, as well as the brightness distribution pattern across the observable surface of the diffuser.

It shall be understood that the observable portion of the diffuser element body need not be perfectly diffuse, but must have substantial light diffusing properties. It shall also be understood that, as hereinafter described, the entire diffuser element need not be diffuse, but only at least an observable portion of the diffuser element needs to be diffuse.

It shall also be understood that, as used herein, a “contoured surface” is preferably a surface with discreet repeating contours that produce a surface pattern having peaks and valleys and curved or angled transition regions between the peaks and valleys. The peaks or valleys can be a sharp angle, flat or curved.

The present invention is also directed to a method of designing a diffuser element having a light incident surface and a light exiting surface. The method is comprised of the steps of selecting a contour pattern for the light exiting surface of an observable portion of the diffuser element according to the requirements of a particular lighting application, and then choosing a contour pattern for the light incident surface of such observable portion that achieves a desired brightness distribution pattern of the contoured light exiting surface.

Thus, it is the primary objective of the present invention to provide a brightness controlling diffuser element for a light source having characteristics which give a designer more tools to design a lighting fixture to meet different application requirements. Other objects of the invention will be apparent from the following specification and claims.

### BRIEF DESCRIPTION OF THE DRAWINGS

FIG. 1 is a cross-sectional fragmentary view of a conventional prior art diffuser element having a single contoured surface in the form of saw-toothed shaped serrations.

FIG. 2 is a cross-sectional fragmentary view of another form of prior art diffuser having a single contoured surface pattern in the form of rounded peaks and valleys.

FIG. 3 is a graphical representation of opposed contoured surfaces illustrating opposing surfaces of a brightness controlling diffuser element for a light source in accordance with the invention.

FIG. 3A is a graphical representation of the opposing contoured surfaces illustrated in FIG. 3, wherein the opposed contours are shifted relative to each other.

FIG. 4 is a graphical representation of another form of opposing contoured surfaces as used in the present invention.

FIG. 5 is a cross-sectional view of a light diffuser element for a light source in accordance with the invention.

FIG. 6 is a cross-sectional view of a lighting fixture using the light diffuser element illustrated in FIG. 5.

FIG. 7 is cross-sectional view of an alternative embodiment of a light diffuser element for a light source in accordance with the invention.

FIG. 8 is a cross-section view of a lighting fixture using the light diffuser element illustrated in FIG. 7.

FIG. 9 is a fragmentary top perspective view of a lighting fixture another alternative embodiment of a light diffuser element for a light source in accordance with the invention.

FIG. 10 is a cross-sectional view thereof.

### DETAILED DESCRIPTION OF THE ILLUSTRATED EMBODIMENT

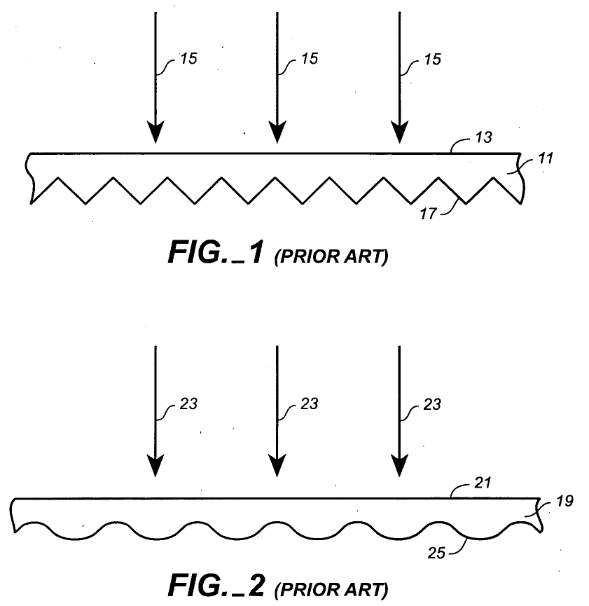

Referring to the drawings, FIGS. 1 and 2 show exemplary light diffuser forms known in the prior art used in lighting applications. In FIG. 1, the diffuser 11 has a flat light incident surface 13 which receives light from a light source (not shown), as represented by light ray arrows 15. Opposed to the flat light incident surface 13 is a contoured surface in the form of saw-toothed shaped serrations 17. In FIG. 2, the diffuser 19 similarly has a flat light incident surface 21 for receiving source light as represented by light ray arrows 23. In this form, the light exiting surface 25 of the diffuser is provided in the form of rounded peaks and valleys. In each of the foregoing examples of prior art diffusers, the light exiting surfaces have different visual characteristics. Each will also have a characteristic brightness distribution which is dictated by the particular surface patterns on the light exiting surfaces 17, 25 of the diffusers. These surface brightness distribution characteristics are tied to the bottom surface patterns and, for a given lighting fixture, cannot be changed without changing contours of the diffuse surface.

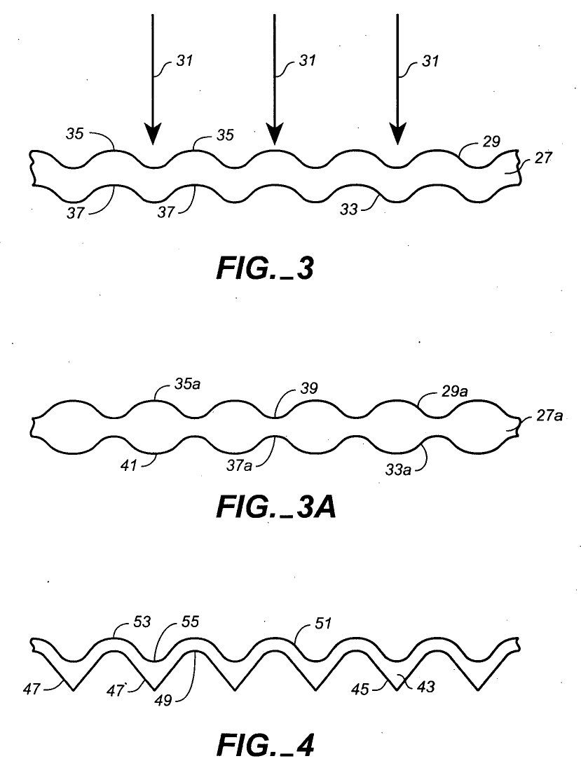

FIGS. 3, 3A and 4 illustrate the principle of a repeating double contoured surface for the diffuser portion of a diffuser element in accordance with the present invention. In FIG. 3, the diffuser element 27 has a light incident surface 29 illuminated by a light source as indicated by light rays 31, and a light exiting surface 33. Both surfaces 29, 33, are contoured in this case, instead of just one surface. The contours consist of repeating and complementary rounded peaks and valleys, with the peaks of one surface, such as peak 35 on the light incident surface 29, opposing the valleys of the opposing surface, such as valleys 37 of the light exiting surface 33. While the light exiting surface 33 has a particular visual characteristic, the brightness distribution across this surface will have been altered as compared to the prior art diffuser element shown in FIG. 2, which has a similar surface pattern on its light exiting surface 25, but a flat surface on its light incident surface. Moreover, the brightness distribution across the peaks and valleys of the diffuser element illustrated in FIG. 3 can further be altered by altering the surface pattern of the light incident surface 29, such as shifting the relative position of the contours on surface 29 relative to the contours on surface 33 as illustrated in FIG. 3A.

In FIG. 3A, diffuser element 27a has a bottom light exiting surface 33a, which is substantially identical to surface 33 for the diffuser element illustrated in FIG. 3. The top light incident surface 29a, however, is shifted such that the peaks and valleys 35a, 41, and 37a, 39 of the top and bottom surfaces are in opposition to each other. It is noted that such shifting changes the diffuser element from one of a substantially uniform thickness as shown in FIG. 3, to one having a varying thickness as shown in FIG. 3A. These thickness variations will cause changes in the surface brightness characteristics across the light exiting surface. It will be appreciated that a lighting designer can achieve different brightness distributions across the light exiting surface of the diffuser by adjusting the relative placement of the contours on the top light incident surface and bottom light exiting surface. Additional flexibility in achieving desired brightness patterns can be accomplished by changes in the shape of the contours on the light incident surface.

FIG. 4 shows yet another diffuser having double contoured surfaces in accordance with the invention. In this embodiment, the diffuser 43 has a bottom light exiting surface 45 with saw-toothed shaped peaks 47 and rounded valleys 49. The diffuser's top light incident surface 51 is provided with a contoured surface pattern consisting of both rounded peaks 53 and rounded valleys 55. In this embodiment, the peaks and valleys of the top and bottom surfaces of the diffuser, like the embodiment shown in FIG. 3, oppose each other, however, unlike the FIG. 3 embodiment, the diffuser exhibits thickness variations throughout its length due to the different shapes of the contoured surfaces.

It will be appreciated that the diffuser element of the present invention can have light incident and light exiting surfaces with a variety of different contour patterns with different juxtapositions of the contours. Generally, the contour of the light incident surface will be designed to couple a desired amount of light to the light exiting surface to produce a desired amount of brightness within particular areas across this surface. The degree of coupling in a particular area of the body of the diffuser element will be a function of the relative angles of opposing surfaces and the thickness of the body within that area. Once the visible surface pattern characteristics of the visible light exiting surface have been set, the design tools available to the designer for achieving a desired brightness distribution across this surface include establishing point-by-point the contour on the light incident surface, including angles and thickness, which provides the degree of light coupling through the diffuser body necessary to achieve the target brightness distribution pattern.

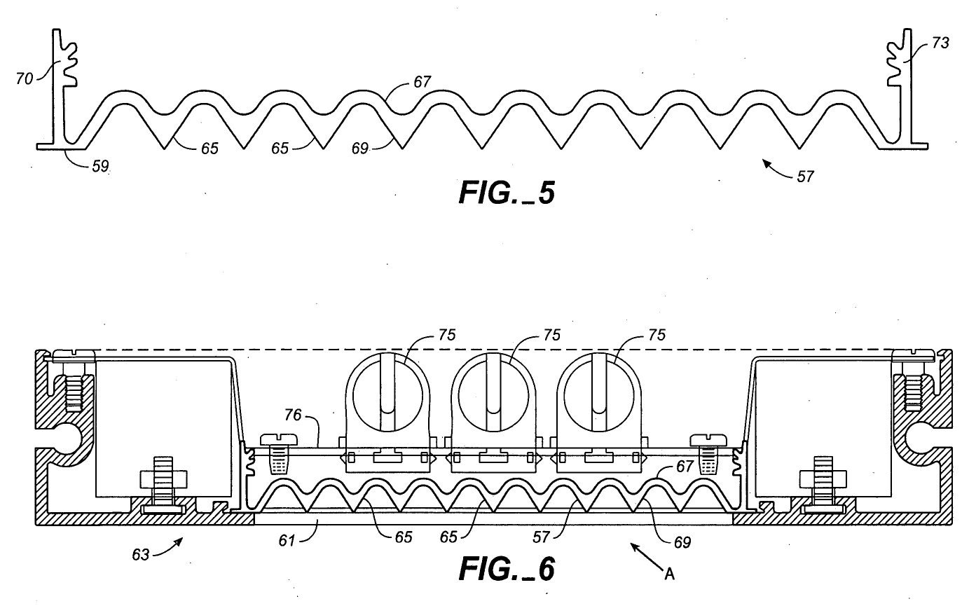

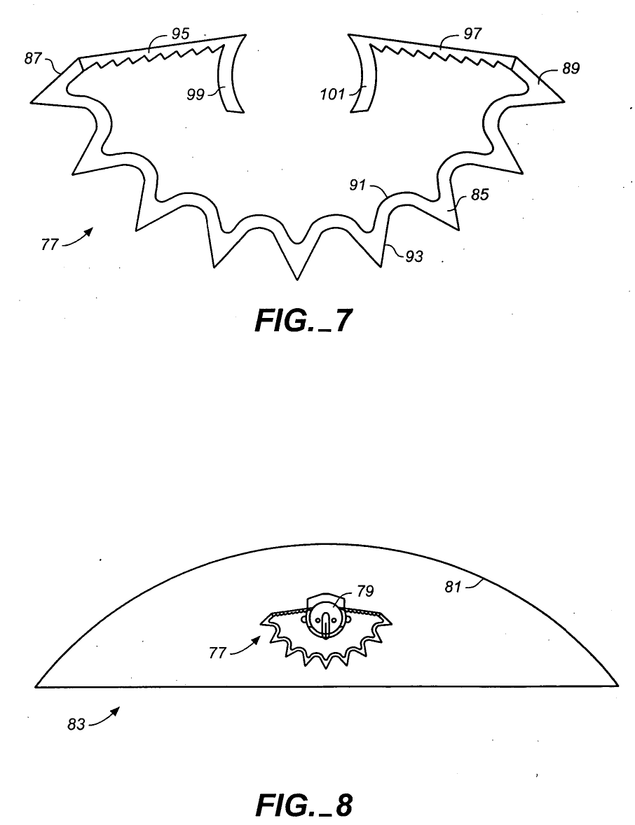

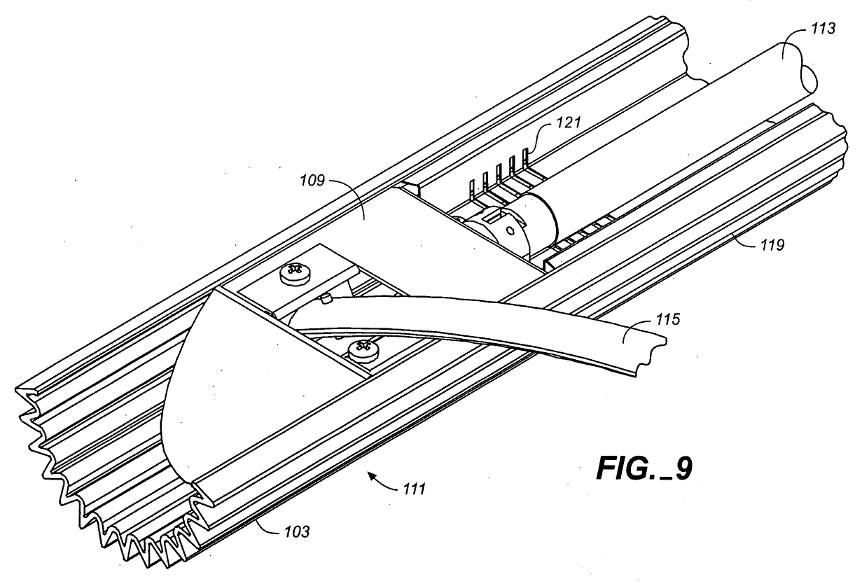

FIG. 5 shows a diffuser element in accordance with the invention for insertion into a lighting fixture such as shown in FIG. 6. FIG. 7 is an alternative embodiment of a light diffuser element for securement to a fluorescent lamp of a lighting fixture as shown in FIG. 8.

Referring to FIGS. 5 and 6, the diffuser element 57 is comprised of an elongated body having a uniform cross-sectional shape and a width and length that allows the extruded diffuser element to be placed in the bottom opening 61 of linear lighting fixture 63. The body of the diffuser element is seen to include an observable portion 65, which lies in a flat, horizontal plan, and which has a contoured top light incident surface 67 and a contoured bottom light exiting surface 69. The contoured top and bottom surfaces 67, 69 of the observable portion of this diffuser element corresponds to the double contoured form described and illustrated in FIG. 4. The body of the diffuser element additionally includes upwardly extending snap-in tabs 71, 73 for snapping the diffuser element into the lighting fixture 63 as shown in FIG. 6.

Referring to FIG. 6, it can be seen that the top light incident surface 67 of the observable portion of the diffuser element 57 receives source light from the fixture's fluorescent lamp 75 positioned above the diffuser element. The source light passes through a slotted reflector 76, which extends beneath the fluorescent lamps between the lamps and the diffuser element. When viewed by an observer at normal viewing angles, such as the viewing angle denoted by the arrow A, the light exiting surface of the observable portion of the diffuser element 57 will present a characteristic surface pattern to the observer as well as a characteristic brightness distribution pattern across the peaks and valleys of the diffuser element. This distribution pattern will be determined by the selection of the double contoured surfaces on the light incident surface 67 and the light exiting surface 69 of the observable portion of the diffuser element in conjunction with the placement of the diffuser element in relation to the lamps 75.

Referring to FIGS. 7 and 8, the diffuser element 77 illustrated in these figures is in the form of an elongated diffuser element that wraps in a curved plane around the fluorescent lamp 79, which is positioned below the reflector 81 of fluorescent down lighting fixture 83. In this form, the observable portion 85 of the diffuser element extends upwardly in a generally cylindrical configuration to top edges 87, 89. As in the previously described embodiment, this embodiment of the diffuser element has a contoured top light incident surface 91 and a contoured bottom light exiting surface 93. The light exiting surface is chosen to provide a characteristic observable surface pattern, while the light incident surface is chosen to create a desired brightness distribution pattern on the light exiting surface.

The body of the diffuser element shown in FIGS. 7 and 8 additionally include top extension walls 95, 97 that extend inwardly from the top edges 87, 89 of the observable portion of the diffuser element. Downwardly extending arcuate tabs 99, 101 provided at the end of these extension walls, have a radius which conforms to the radius of the lamp to which the diffuser element will be attached. As best shown in FIG. 8, the diffuser element is secured to the lamp by snapping the tabs 99, 101 onto the lamp. This is achieved by flexing body of the diffuser element slightly to separate the tabs.

It is noted that the extension walls 95, 97 can be provided with prismatic surfaces, such as the illustrated bottom prismatic surfaces 103, 105, for redirecting the light passing through these extension walls. It is also noted the extension walls need not be diffuse, but could be opaque or transparent.

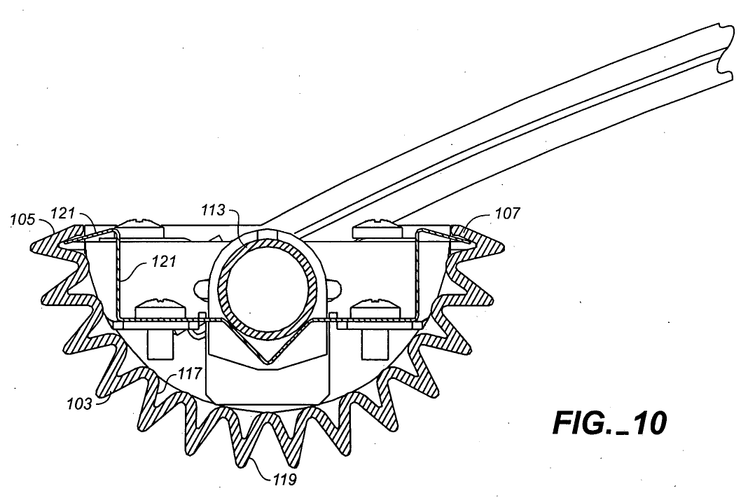

FIGS. 9 and 10 show another variation of the wrap around diffuser configuration seen in FIGS. 7 and 8. In this embodiment, diffuser element 103 has side walls that extend upwardly in a semi-cylindrical shape and terminate at two inwardly projecting lips 105, 107, which hook onto an internal bracket 109 from which the linear lighting fixture element 111 supporting fluorescent tube 113 can be suspended, such as by hanger 115. The diffuser element is comprised of a body having a contoured top light incident surface 117 positioned generally below the lamp 113 and a contoured bottom light exiting surface 119 opposed to the light incident surface. Since the diffuser element extends beyond the lamp, the observable luminous portion of the diffuser element will be between the ends of the diffuser element body. The brightness distribution pattern on the observable luminous portion of the body in this embodiment is produced from source light passing through slots 121 in reflector 123 (only a few of these slots are shown in FIG. 9).

The diffuser elements shown and described in FIGS. 5-10 each have a uniform cross-section shape and can suitably be fabricated of a plastic material having diffuse properties by an extrusion or co-extrusion process. However, it shall be understood that the invention is not limited to the use of plastic or any particular fabrication process. For example, the diffuser element or a portion thereof could be made of glass.

It shall also be understood that the invention is not limited to the illustrated embodiment, and that other variation of the diffuser element of the invention are possible within the spirit and scope of the invention. For example, and not by way of limitation, the diffuser element need not be a linear element for a linear fluorescent fixture, but could have a bowl shape with double contoured surfaces or other shapes surrounding a point source of light. The contoured surfaces can also take other forms than illustrated herein, such as concentric rings of peaks and valleys on both surfaces of the diffuser.

While the invention has been described in considerable detail in the foregoing specification, it is not intended that the invention be limited to such detail, except as necessitated by the following claims.

What I claim is:

1. A light diffuser element for a source of light comprising
a body having an observable portion fabricated of a light diffusing material,
the observable portion of said body having a light incident surface and a light exiting surface opposed to said light incident surface,
the light incident and light exiting surfaces of said observable portion being contoured to produce opposing contoured surface patterns, the contours of the contoured surface pattern for said light exiting surface being chosen to achieve a desired visual characteristic for said light exiting surface, and the contours of the contoured surface pattern for said light incident surface being chosen to achieve a desired brightness distribution across the contoured surface pattern of said light exiting surface.

2. The light diffuser element of claim 1 wherein the contoured surface patterns of said light incident surface and a light exiting surface have repeating contours having peaks and valleys.

3. The light diffuser element of claim 2 wherein the peaks of said light incident surface oppose the valleys of said light exiting surface and the valleys of said light incident surface oppose the peaks of said light exiting surface.

4. The light diffuser element of claim 2 wherein the peaks of said light incident surface oppose the peaks of said light exiting surface and the valleys of said light incident surface oppose the valleys of said light exiting surface.

5. The light diffuser element of claim 2 wherein the relative position of peaks and valleys of the contoured surfaces on the observable portion of said body is selected to achieve variations in thickness of said observable portion.

6. The light diffuser element of claim 1 wherein the contoured surface patterns on said light incident and light exiting surfaces have different contour forms.

7. The light diffuser element of claim 6 wherein the form of the contoured surface pattern on said light exiting surface is a serrated sw tooth form and the the form of the surface pattern on said light incident surface is a form having rounded peaks and valleys.

8. The light diffuser element of claim 1 wherein the observable portion of said body lies in a flat plane.

9. The light diffuser element of claim 1 wherein the observable portion of said body lies in a curved plane.

10. The light diffuser element of claim 9 wherein the observable portion of said body extends upwardly in a curved plane to form top edges, and further comprising
top extension walls that extend inwardly from said top edges, and
opposing arcuate tabs at the end of said extension walls, each of said opposing arcuate tabs having a radius which conforms to the radius of a lamp to which the diffuser element is to be attached and being spaced to receive a lamp to which it is to be attached.

11. The light diffuser element of claim 9 wherein said top extension walls are diffuse.

12. The light diffuser element of claim 9 wherein said top extension walls are transparent.

13. The light diffuser element of claim 9 wherein at least one of said extension walls has a prismatic surface for redirecting light passing through said extension wall.

14. A light diffuser element for a source of light comprising
an body having an observable portion fabricated of an extruded light diffusing material,
the observable portion of said body having a light incident surface and a light exiting surface opposed to said light incident surface,
each of the light incident and light exiting surfaces of said observable portion having a repeating contoured surface pattern having peaks and valleys.

15. The light diffuser element of claim 14 wherein the positions of the peaks and valleys of said light incident surface relative to the peaks and valleys of said a light exiting surface are chosen to achieve a desired brightness distribution across the repeating contoured surface pattern of said light exiting surface.

16. The light diffuser element of claim 15 wherein the repeating contoured surface patterns on said light incident and light exiting surfaces have different contour forms.

17. The light diffuser element of claim 16 wherein the form of the repeating contoured surface pattern on said light exiting surface is a serrated saw tooth form and the form of the repeating surface pattern on said light incident surface is a form having rounded peaks and valleys.

18. The light diffuser element of claim 14 wherein the observable portion of said body lies in a flat plane.

19. The light diffuser element of claim 14 wherein the observable portion of said body lies in a curved plane.

20. A method of designing a diffuser element having a light incident surface and a light exiting surface, said method comprising
selecting a contour pattern for the light exiting surface of an observable portion of the diffuser element according to the requirements of a particular lighting application, and
choosing a contour pattern for the light incident surface of such observable portion that achieves a desired brightness distribution pattern of the contoured light exiting surface.
